(19) United States
(12) Patent Application Publication
(10) Pub. No.: US 2009/0125829 A1
(43) Pub. Date: May 14, 2009

(54) AUTOMATED YIELD SPLIT LOT (EWR) AND PROCESS CHANGE NOTIFICATION (PCN) ANALYSIS SYSTEM

(75) Inventors: ANDREW S. DALTON, NEW MILFORD, CT (US); JAMES P. RICE, DANBURY, CT (US); YUNSHENG SONG, POUGHKEEPSIE, NY (US); SUSAN L. TEMPEST, HOPEWELL JUNCTION, NY (US); TSO-HUI TING, STORMVILLE, NY (US)

Correspondence Address: FREDERICK W. GIBB, III;Gibb Intellectual Property Law Firm, LLC, 2568-A RIVA ROAD, SUITE 304, ANNAPOLIS, MD, 21401, US

(73) Assignee: INTERNATIONAL BUSINESS MACHINES CORPORATION, ARMONK, NY (US)

(21) Appl. No.: 11/937,012

(22) Filed: Nov. 8, 2007

(51) Int. Cl. G06F 3/048

(52) U.S. Cl. 715/771

(57) ABSTRACT

Disclosed are an automated data analysis system and method. They system provides a standardized data analysis request form that allows a user to select an experiment (e.g., a wafer-level based yield split lot (EWR) analysis, a lot-level based process change notification (PCN) analysis, and lot-level based tool/mask qualification analysis) and a data analysis for a specific process module of interest. For each specific data analysis request, the system identifies critical test parameters, which are grouped depending on in-line test levels and photolithography levels. The system links the analysis request to test data sources and automatically monitors the test data sources, searching for the critical test parameters. When the critical test parameters become available, the system automatically performs the requested analysis, generates a report of the analysis and publishes the report with optional drill downs to more detailed results. The system further provides automatic e-mail notification of the published report.

### BACKGROUND

1. Field of the Invention

The embodiments of the invention generally relate to automated data analysis systems and, more particularly, to an automated system for performing various data analyses, including but not limited to, yield split lot (EWR) analyses, process change notification (PCN) analyses and tool/mask qualification analyses, during development and manufacture of semiconductor products.

2. Description of the Related Art

During development and manufacturing of semiconductor products, manufacturing process engineers and/or integration engineers spend a great deal of time tracking their hardware to test points and then manually requesting different types of data analyses (e.g., yield split lot (EWR) analyses, process change notification (PCN) analyses, and/or tool/mask qualification analyses) be performed by characterization engineers. Each of the different types of data analyses requires a specific set of critical test parameters (i.e., relevant test data) to be selected and analyzed from amongst thousands of potentially available test parameters. Thus, the requesting engineer must be a skilled engineer with process and characterization experience in order to identify what test parameters are critical to a given type of analysis and to determine when those critical test parameters are available. Furthermore, since each analysis request, including selection of the critical test parameters, is made manually, there are inevitably unnecessary time delays between when the critical test parameters actually become available and when the data analysis request is eventually made.

Additionally, after semiconductor wafers are tested and a data analysis request (e.g., a an EWR analysis request, a PCN analysis request or a tool/mask qualification analysis request) is made by a requesting engineer to a characterization engineer, the characterization engineer typically manually accesses the critical test data using various applications, performs the requested analysis and generates a summary report of the analysis. The characterization engineer then typically posts the summary report in a database and manually sends out a notification to the requesting engineer that the summary report is available for review. The various manual process steps associated with accessing the test data, performing the analysis and reporting the results of a data analysis, inevitably result in unnecessary time delays between when the analysis request is made and when the summary report is made available to the requesting engineer. Furthermore, characterization engineers must prioritize the performance of the requested time-consuming analyses with the performance of other duties, including but not limited to, critical daily signal monitoring.

The above-described delays (e.g., from when critical test parameters actually become available, to when the data analysis request is made by the requesting engineer to the characterization engineer, to when the data analysis is performed and further to when the summary report is made available to the requesting engineer) often result in delayed yield learning and reduced manufacturing productivity. Therefore, there is a need in the art for an automated data analysis system that more efficiently performs test data analyses (e.g., EWR, PCN, and tool/mask qualification analyses) in a semiconductor product manufacturing environment and, thereby, avoids delayed yield learning and reduced productivity.

### SUMMARY

In view of the foregoing, disclosed herein are embodiments of an automated data analysis system for use in a semiconductor product manufacturing environment and an associated method.

The system comprises a graphical user interface (GUI), at least one test data source, a data storage device, a data monitor, a data retriever, a data analyzer, and a report generator. The GUI can be adapted to display a standardized data analysis request form having a plurality of input fields. Each of the input fields allows a user to identify at least a specific experiment to be conducted, during fabrication of a semiconductor product, and a specific data analysis to be performed on test data generated during the specific experiment. The test data source(s) can be adapted to store test data generated during semiconductor product fabrication and, more specifically, during the specific experiment. The data monitor can be in communication with the graphical user interface, the processor and the test data source(s). This data monitor can be adapted to monitor the test data source(s) to determine if the specific test data is currently stored in the test data source(s). The data retriever can be in communication with the data monitor and the test data source(s). This data retriever can be adapted to retrieve the specific test data from the test data source(s), once the data monitor determines that it is available. The data analyzer can be in communication with the data retriever. This data analyzer can be adapted to receive the specific test data from the data retriever and to automatically perform the specific data analysis requested by the user. The report generator can be in communication with the data analyzer and can be adapted to automatically generate and update, as necessary, a summary report, based on results of the specific data analysis. For example, the report generator can be adapted to generate and automatically display, on a designated web page, a summary report with drill down capabilities (i.e., links) to access the test results.

Also disclosed herein are embodiments of an automated data analysis method. The method comprises displaying, on a graphical user interface (GUI), a standardized data analysis request form. Input field selections are received from a user, wherein the user identifies a specific experiment to be conducted, during fabrication of a semiconductor product, and a specific data analysis to be performed on specific test data. The method further comprises automatically monitoring one or more test data sources to determine the availability of specific test data that is generated during the experiment and that is required for the specific data analysis. That is, a determination is made as to whether or not the specific test date is currently stored in the test data source. Once the specific test data becomes available, the test data source is automatically accessed and the specific test data is retrieved. Next, the specific data analysis requested by the user is performed using the retrieved test data. After the specific data analysis is completed, a summary report, based on the results of the specific data analysis, can be automatically generated.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such changes and modifications.

### BRIEF DESCRIPTION OF THE DRAWINGS

The embodiments of the invention will be better understood from the following detailed description with reference to the drawings, in which:

FIG. 1 is a block diagram illustrating an embodiment of an automated data analysis system of the invention;

FIG. 2 represents a graphical user interface screen display of an exemplary standardized data analysis request form for use in conjunction with the system of FIG. 1;

FIG. 3 represents a graphical user interface screen display of an exemplary listing of identified critical test parameters that are associated with a specific data analysis request and generated using the system of FIG. 1;

FIG. 4 represents a graphical user interface screen display of an exemplary web page providing links to reports and other stored documents, including analysis reports generated using the system of FIG. 1;

FIG. 5 represents a graphical user interface screen display of an exemplary document linked to FIG. 4;

FIG. 6 represents a graphical user interface screen display of an exemplary document linked to FIG. 5;

FIG. 7 represents a graphical user interface screen display of an exemplary document linked to FIG. 6;

FIG. 8 represents a graphical user interface screen display of an exemplary document linked to FIG. 7;

FIG. 9 represents a graphical user interface screen display of another exemplary document linked to FIG. 7;

FIG. 10 is a flow diagram illustrating an embodiment of an automated data analysis method of the invention; and

FIG. 11 is a block diagram illustrating a representative hardware environment for practicing the embodiments of the invention.

### DETAILED DESCRIPTION OF EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

As mentioned above, during development and manufacturing of semiconductor products, manufacturing process engineers and/or integration engineers spend a great deal of time tracking their hardware to test points and then manually requesting different types of data analyses be performed by characterization engineers. Since each analysis request, including selection of the critical test parameters, is made manually, there are inevitably unnecessary time delays between when the critical test parameters actually become available and when the data analysis request is eventually made. Additionally, after semiconductor wafers are tested and a data analysis request is made by a requesting engineer to a characterization engineer, the characterization engineer typically manually accesses the critical test data using various applications, performs the requested analysis and generates a summary report of the analysis. The characterization engineer then typically posts the summary report in a database and manually sends out a notification to the requesting engineer that the summary report is available for review. The various manual process steps associated with accessing the test data, performing the analysis and reporting the results of a data analysis, inevitably result in unnecessary time delays between when the analysis request is made and when the summary report is made available to the requesting engineer. The above-described delays (e.g., from when critical test parameters actually become available, to when the data analysis request is made by the requesting engineer to the characterization engineer, to when the data analysis is performed and further to when the summary report is made available to the requesting engineer) often result in delayed yield learning and reduced manufacturing productivity.

In view of the foregoing, disclosed herein are embodiments of an automated data analysis system for use in a semiconductor product manufacturing environment and an associated method. The disclosed system is designed to analyze specific and relevant data to a particular process change or experiment without manual intervention, after system initialization. This is accomplished through the use of an input that defines process module and photolithography levels affected by the experiment to determine relevant data analysis.

Specifically, the system provides a standardized data analysis request form on a graphical user interface (GUI). The standardized request form allows a user (e.g., a manufacturing process engineer and/or an integration engineer) to select an experiment (e.g., a wafer-level based yield split lot (EWR) analysis, a lot-level based process change notification (PCN) analysis, and lot-level based tool/mask qualification analysis) and a data analysis for a specific process module of interest. For each specific data analysis request, the system identifies critical test parameters, which are grouped depending on in-line test levels and integration/process levels (i.e., photolithography levels). Once the analysis request is submitted, the system links the analysis request to test data source(s) which maintain the test data. The system automatically monitors the test data source(s), searching for the critical test parameters. When the critical test parameters become available, the system automatically performs the requested statistical analysis, generates a summary report of the analysis and publishes the summary report (e.g., on a web page) with optional drill downs to more detailed reports/data. The summary report can highlight changes (e.g., in process or tools) which have a significant impact on functional yield. The system can further provide automatic e-mail notification of the published summary report to the requesting user as well as to other users having an interest in the summary report (e.g., the characterization engineers/lead technology analysts, etc.).

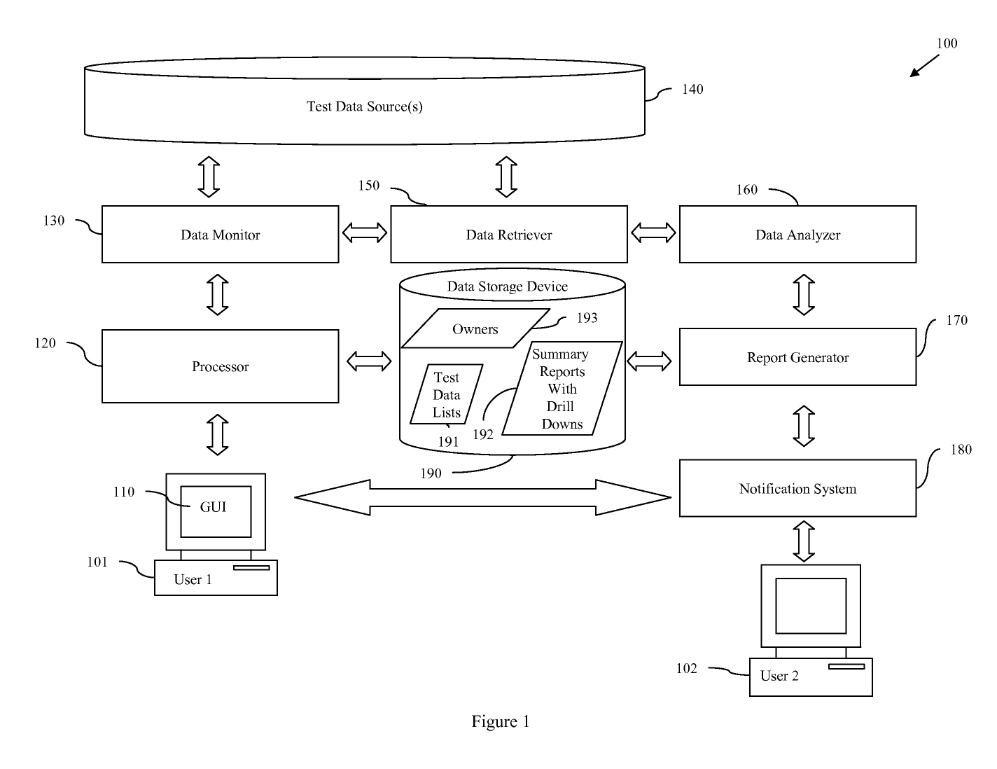

More particularly, referring to FIG. 1, disclosed herein are embodiments of an automated data analysis system 100 that can be used during semiconductor product fabrication in order to avoid delayed yield learning and reduced productivity. The system 100 comprises a graphical user interface (GUI) 110 with a standardized data analysis request form, at least one test data source 140, a data storage device 190, a processor 120, a data monitor 130, a data retriever 150, a data analyzer 160, a report generator 170 and a notification system 180.

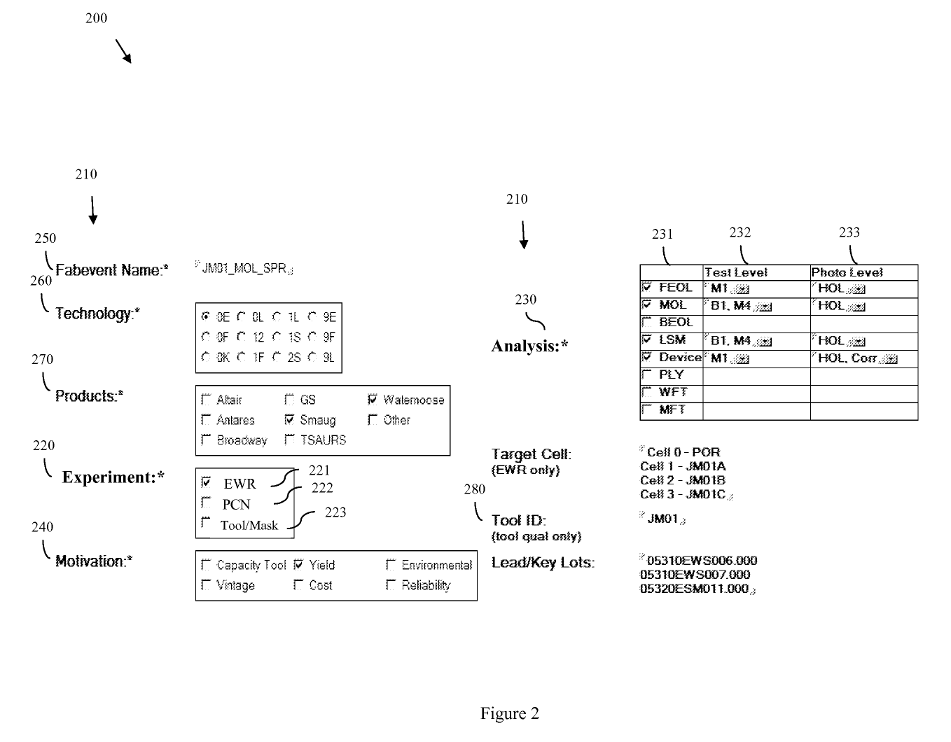

The GUI 110 can be adapted to display a standardized data analysis request form 200 having a plurality of input fields 210 (see FIG. 2). Each of the input fields 210 allows a user 101 (e.g., a manufacturing process engineer and/or an integration engineer) to select from a plurality of options in order to identify at least a specific experiment to be conducted, during fabrication of a semiconductor product, and a specific data analysis to be performed on test data generated during the specific experiment upon. For example, one input field on the form 200 can comprise an experiment type input field 220 adapted to allow the user to make a selection from amongst various different experiment types (e.g., a wafer-level yield split lot (EWR) analysis 221, a lot-level process change notification (PCN) analysis 222, a tool/mask qualification 223, etc.).

Another input field on the form 200 can comprise a data analysis input field 230 adapted to allow the user to make a selection of a specific process module 231 (e.g., a front end of the line (FEOL) level analysis, middle of the line (MOL) level analysis, back end of the line (BEOL) analysis, line SRAM monitor (LSM) analysis, device level analysis, photo-limited yield (PLY) analysis, wafer final test (WFT) analysis, etc.) This data analysis input field 230 can further be adapted to allow the user to make a selection of one or more in-line test levels 232 and/or one or more photolithography levels 233 for the specific process module 231 selected. Thus, the data analysis type input field 230 defines the data type (i.e., electrical, PLY or functional) to be analyzed.

Yet another of the input fields 210 on the form 200 can comprise a motivation input field 240 that defines the motivation for performing the experiment and the analysis (e.g., cost, yield, reliability, environmental impact, etc.). Additional input fields 210 that further define the analysis request can include, but are not limited to, a fabrication event input field 250 (e.g., defining the lots/wafers on which the experiment is performed), a technology type input field 260 (e.g., defining the specific semiconductor technology), a product input field 270 (e.g., defining the specific semiconductor product), a tool identification field, etc.

In an exemplary data analysis request, a EWR 221 or PCN 222 experiment can be defined (i.e., selected) in the request form 200 and this experiment 221 or 222 can be associated with the introduction of a modified process step during semiconductor product fabrication. In order to evaluate product yield in response to the modified process step, the user can request that a specific data analysis 231 be performed on specific test data associated with user-selected in-line test 232 and/or photolithography 233 levels that are most likely to be impacted by the modified process step. Alternatively, a tool/mask qualification experiment 223 can be defined (i.e., selected) in the request form 200 and this experiment 223 can be associated with the introduction of a new tool or mask during semiconductor product fabrication. In order to evaluate product yield in response to the new tool/mask, the user can request that a specific data analysis 231 be performed on specific test data associated with user-selected in-line test 232 and/or photolithography 233 levels that are most likely to be impacted by the new tool or mask. Once a request form 200 is submitted it may be automatically converted into an appropriate file document and saved in database 191.

Referring again to FIG. 1, the test data source(s) 140 can comprise, for example, a distributed information warehouse, adapted to store test data generated during semiconductor product fabrication and, more specifically, during the specific experiment. The data storage device 190 can comprise one or more databases. For example, one database 191 can contain lists of test data (i.e., lists of critical test parameters) required to perform various different types of data analyses. Specifically, this database 191 can be created by characterization engineers in each technology during initial system 100 set up. The lists can define the relevant data (i.e., the critical test parameters) for performing various process and/or tool/mask qualification experiments in each technology and can further categorize the electrical, PLY and physical test parameters into three groups or buckets: by process module, by in-line test/inspection level and by photolithography level. Another database 193 that can be maintained in the data storage device 190 can contain lists of characterization/technology owners (i.e., characterization engineers, lead technology analysts, or other interested persons associated with each process module in each technology).

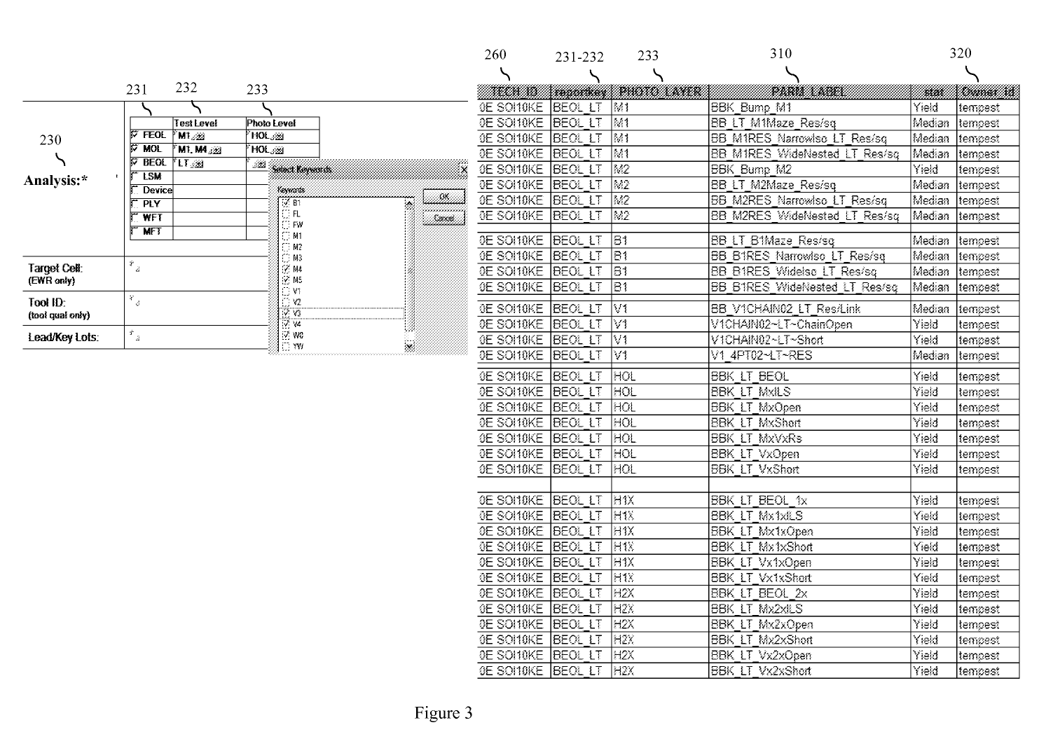

The processor 120 can be in communication with the graphical user interface 110, the data storage device 190 and the data monitor 130. This processor 120 can be adapted to automatically access the test data lists in the database 191 of the data storage device 190 and, based on the selection of a specific process module and the selection of the one or more in-line test levels and/or photolithography levels, to identify the specific test data that will be generated during the specific experiment and that will be required to perform the specific data analysis. The processor 120 can further be adapted to automatically access the characterization engineer/analyst database 193 of the data storage device 190 and, based on the selection of a specific process module and the selection of the one or more in-line test levels and/or photolithography levels, notify (via the notification system 180) other interested persons 102 associated with the specific process module identified in the request that the specific data analysis request has been made. For example, as illustrated in FIG. 3, for a selected technology 260, the selected process modules 231, selected in-line test levels 232 and selected photolithography levels 233 will be associated by the processor 120 with the listed specific test parameters 310 using the database 191 of FIG. 1 as well as with the listed characterization/technology owners 320 (e.g., characterization engineers, lead technology analysts, etc.) using the database 193 of FIG. 1.

The data monitor 130 can be in communication with the graphical user interface 110, the processor 120 and the test data source(s) 140. This data monitor 130 can be adapted to monitor the test data source(s) 140 to determine if the specific test data, which was identified by the processor as being generated during the specific experiment and which was further identified by the processor as being required to perform the specific data analysis, is currently stored in the test data source(s) 140. For example, the data monitor 130 can make periodic (e.g., daily) inquiries of submissions made to the test data source(s) by searching for specific lots/wafers associated with the particular fabrication event and checking to see if the required critical test parameters are stored. The data retriever 150 can be in communication with the data monitor 130 and the test data source(s) 140. This data retriever 150 can be adapted to retrieve the specific test data from the test data source(s) 140, once the data monitor 130 determines that it is available.

The data analyzer 160 can be in communication with the data retriever 150. This data analyzer 160 can be adapted to receive the specific test data from the data retriever 150 and to automatically perform the specific statistical data analysis requested by the user (e.g., yield, cost, reliability, environmental impact, etc.), using the specific test data identified by the processor 120 and retrieved by the data retriever 150 from the test data source(s) 140. For electrical PCN/EWR and functional EWR analysis as long as the first lot is tested, the automated analysis will start. Then, whenever, new data becomes available (e.g., data from additional lots), the reports generated by the report generator 170 based on the analysis (see detailed discussion below) will simply be updated. However, for functional PCN analysis it is preferred that data from at least three lots be available before the automated analysis is initiated. Those skilled in the art will recognize that the automated analysis can be accomplished using conventional statistical analysis techniques, including but not limited to, a comparison of experimental data to previously recorded data.

The report generator 170 can be in communication with the data analyzer 160 and can be adapted to automatically generate a data output in light of the analysis performed. For example, the report generator 170 can be adapted to generate a summary report, based on results of the specific data analysis.

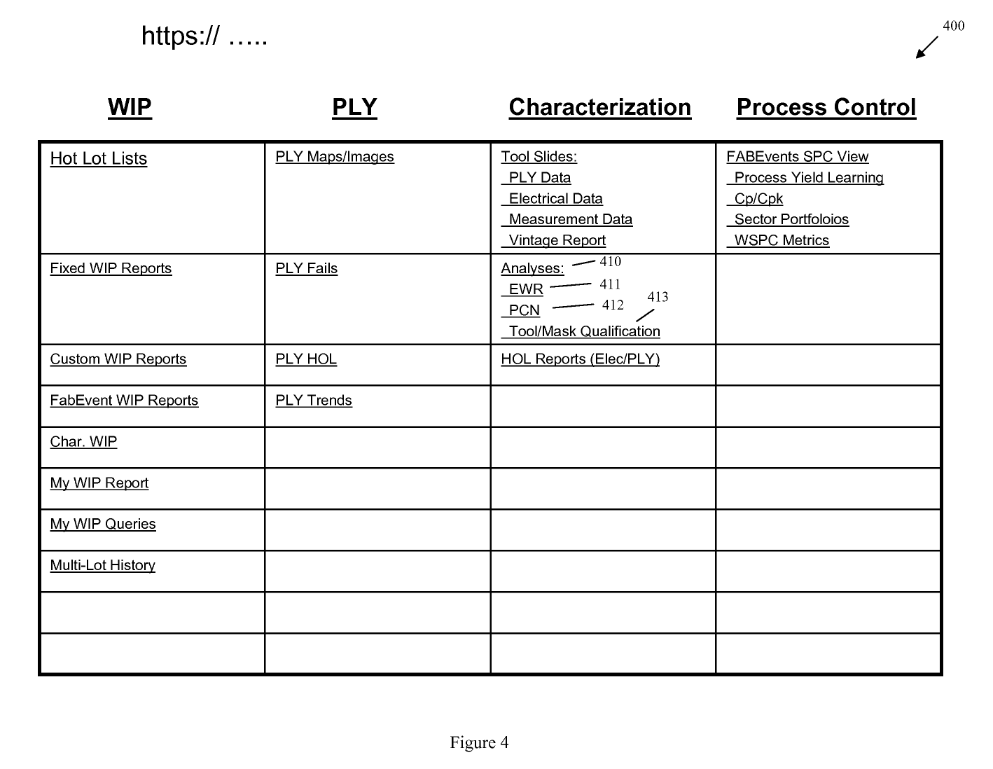

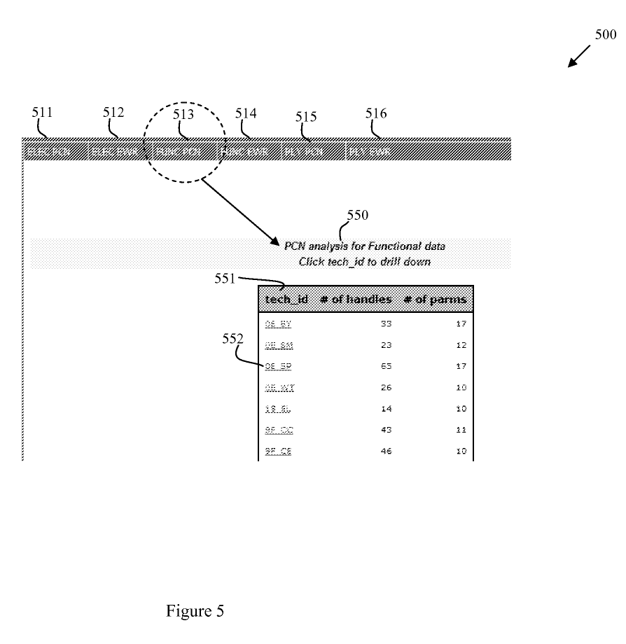

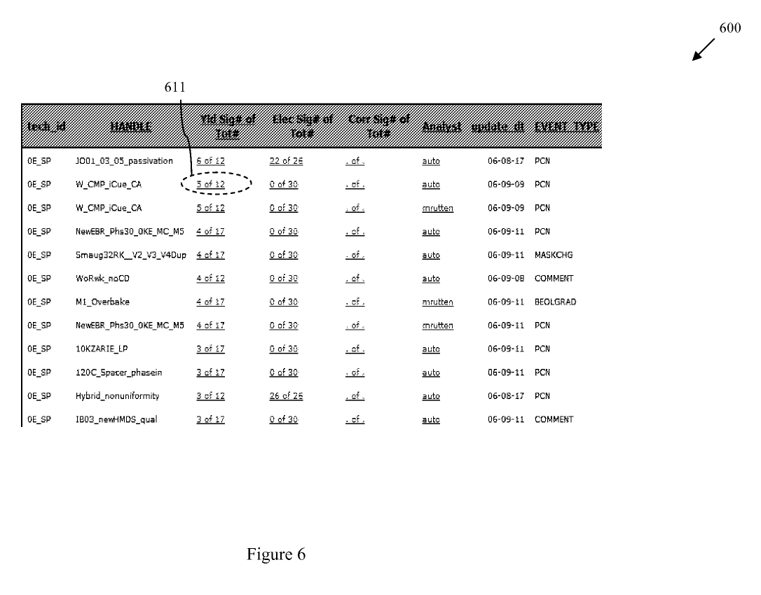

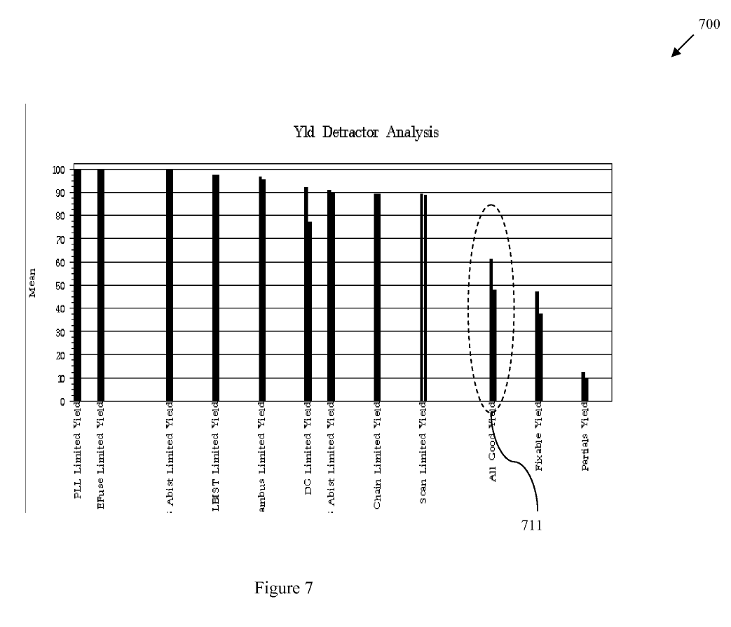

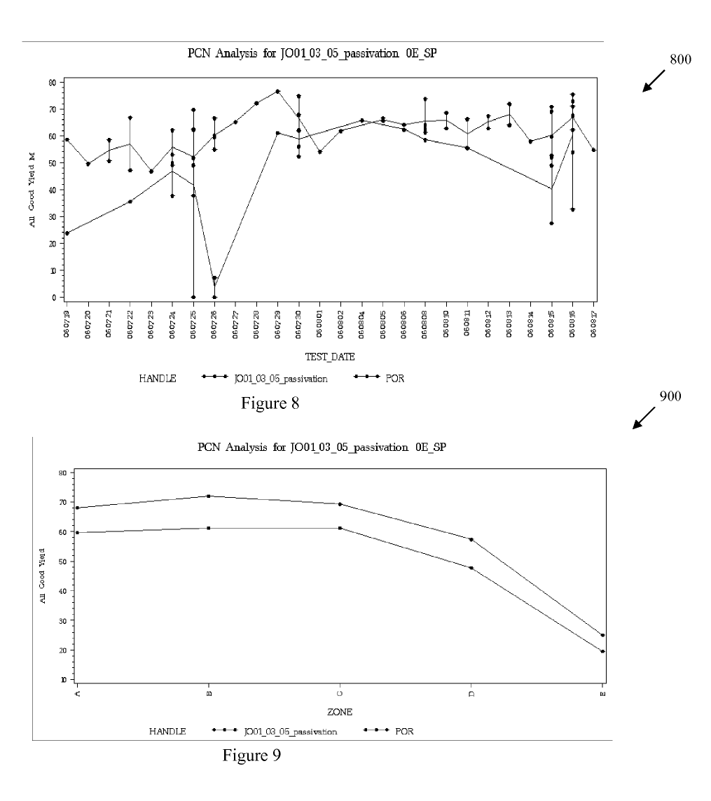

For example, the report generator 170 can be adapted to generate and output a hardcopy of the summary report. Alternatively, the report generator 170 can be adapted to generate a softcopy of the summary report and further to store that summary report in a database 193 in the data storage device 192 and to automatically list that summary report on a designated web page. FIG. 4 illustrates an exemplary web page 400 providing links to various reports, charts, lists, etc. in a given technology, including links to various analyses 410 (e.g., EWR analyses 411, PCN analyses 412 and tool/mask qualifications 413). Clicking on, for example, the link 410 of web page 400 can pull up an exemplary web page 500 (see FIG. 5) which provides links 511-516 to reports regarding electrical, functional and PLY analysis according to experiment type (e.g., EWR, PCN, etc.). Clicking on, for example, the link 513 of web page 500 can pull up an exemplary window 550 listing PCN analyses by technology type 551. Clicking on, for example, the link 552 in the window 550 can pull up an exemplary web page 600 (see FIG. 6) which allows a user to sort the PCN analysis list for a given technology by the number of significant limited yields. Clicking on, for example, the link 611 of web page 600 can pull up an exemplary web page 700 (see FIG. 7) illustrating each limited yield split for a given technology and handle. Finally, clicking on, for example, the link 711 of web page 700 can pull up the windows 800 and 900 (see FIGS. 8-9, respectively) which drill down each limited yield by lot/week trend (see FIG. 8) and by wafer-zone/region (see FIG. 9). The drill down capabilities can extend to more and more detailed results (e.g., box and plot trends, scatter plots, histograms, box plots, summary tables, etc.) Thus, the soft copy summary report generated by the report generator 170 can comprise drill down capabilities allowing a user to link directly to more detailed results (e.g., more detailed reports/data) upon which various line items in the summary report are based.

Finally, the notification system 180 can be in communication with the report generator 170, with the requesting user 101 (via GUI 110) and with any other interested users 102. This notification system 180 can be adapted to automatically notify the user of the availability of the summary report. For example, the notification system 180 can comprise an automated email system adapted to automatically email the user either the summary report itself or a web address for accessing a web page with the summary report. Additionally, the notification system 180 can further be adapted to similarly notify at least one additional user 102 of the summary report. For example, the notification system 180 can be adapted to send a similar email to a characterization/technology owner determined by the processor 120, using the database 193, to be associated with the process module 231 selected by the requesting user on the form 200 of FIG. 2.

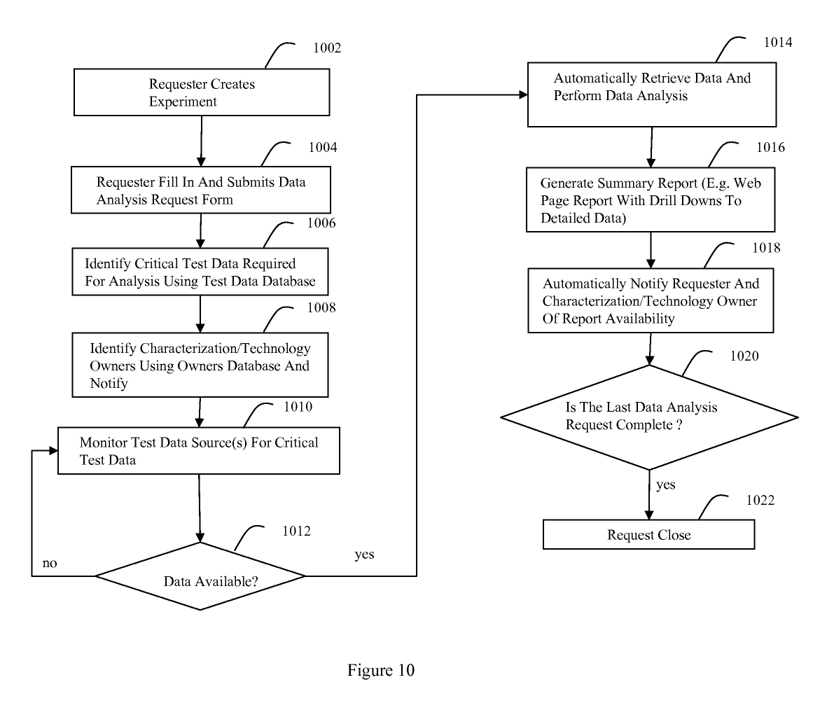

Referring to FIG. 10, also disclosed herein are embodiments of an automated data analysis method that can be used during semiconductor product fabrication in order to avoid delayed yield learning and reduced productivity. The method begins with the creation, by a manufacturing process engineer or an integration engineer, of a fabrication event (i.e., an experiment) to test the impact of a new or modified process, tool or mask by implementing a wafer-level yield split lot (EWR) analysis, a lot-level process change notification (PCN) analysis, and/or a tool/mask qualification in a given process module for a given technology, product, etc (1002).

The automated method comprises displaying, on a graphical user interface (GUI), a standardized data analysis request form having a plurality of input fields each having one or more selection options allowing a user to define the created fabrication event. Specifically, input field selections are received from a user (e.g., from a manufacturing process engineer and/or an integration engineer) so as to fill in the GUI analysis request form (1004). Referring to FIG. 2, by making the selections and filling in the input fields 210 on the form 200 the user identifies at least a specific experiment to be conducted, during fabrication of a semiconductor product, and a specific data analysis to be performed on test data generated during the specific experiment upon. For example, one input field 210 on the form can comprise an experiment type input field 220 and the process of receiving input field selections can comprise receiving, in the experiment type input field, a selection of an experiment type from amongst various experiment types, such as, a wafer-level yield split lot (EWR) analysis 221, a lot-level process change notification (PCN) analysis 222 or a tool/mask qualification 223. Another of the input fields 210 can comprise a data analysis input field 230 and the process of receiving input field selections can comprise receiving, in the data analysis input field 230, a selection of a specific process module 231 (e.g., a front end of the line (FEOL) level analysis, middle of the line (MOL) level analysis, back end of the line (BEOL) analysis, line SRAM monitor (LSM) analysis, device level analysis, photo-limited yield (PLY) analysis, wafer final test (WFT) analysis, etc.) and further receiving, in the data analysis input field 230, a selection of one or more in-line test levels 232 and/or one or more photolithography levels 233 for the specific process module 231 selected. Yet another of the input fields 210 can comprise a motivation input field 240 and the process of receiving input field selections can comprise receiving, in the motivation input field 240, a selection of a specific motivation for completing the experiment and analysis (e.g., cost, yield, reliability, environmental impact, etc.). Additional input fields 210 that further define the analysis request can include, but are not limited to, a fabrication event input field 250 (e.g., defining the lots/wafers on which the experiment is performed), a technology type input field 260 (e.g., defining the specific semiconductor technology), a product input field 270 (e.g., defining the specific semiconductor product), a tool identification field, etc.

In an exemplary request, a EWR 221 or PCN 222 experiment can be defined (i.e., selected) in the request form 200 and this experiment 221 or 222 can be associated with the introduction of a modified process step during semiconductor product fabrication. In order to evaluate product yield in response to the modified process step, the user can request that a specific data analysis 231 be performed on specific test data associated with user-selected in-line test 232 and/or photolithography 233 levels that are most likely to be impacted by the modified process step. Alternatively, a tool/mask qualification experiment 223 can be defined (i.e., selected) in the request form 200 and this experiment 223 can be associated with the introduction of a new tool or mask during semiconductor product fabrication. In order to evaluate product yield in response to the new tool/mask, the user can request that a specific data analysis 231 be performed on specific test data associated with user-selected in-line test 232 and/or photolithography 233 levels that are most likely to be impacted by the new tool or mask.

Additionally, one or more databases 191-193 can be maintained in a data storage device 190 (see FIG. 1). One of these databases can comprise lists of test data (i.e., critical test parameters) required to perform various different types of data analyses can be stored in a data storage device (e.g., in a database). These lists can be grouped by process modules and further by in-line test levels and photolithography levels. Then, after the selection of a specific process module and the selection of the one or more in-line test levels and/or photolithography levels are received at process 1004, these test data lists can be automatically accessed in order to identify the specific test data (i.e., the critical test parameters) that will be generated during the specific experiment and which will be required to perform the specific data analysis (1006). For example, see FIG. 3 and the detailed discussion above.

Another database 193 that can be maintained in the data storage device 190 can comprise stored lists of characterization/technology owners (i.e., characterization engineers, lead technology analysts, or other interested persons associated with each process module in each technology). After the selection of a specific process module at process 1004, these characterization/technology owners list can be used to identify the characterization engineers, lead technology analysts, etc. associated with the process module specified in the request (1008). Once the request is submitted and the associated characterization/technology owners are identified they can be automatically notified (e.g., by email) that the request was made. Once the specific test data is identified at process 1006, then one or more test data sources (e.g., a distributed information warehouse 140 as illustrated in FIG. 1) that store test data generated during the semiconductor product fabrication and, more specifically, that store test data generated during the specific experiment, can be automatically monitored to determine availability of the specific test data (i.e., to determine if the specific test data required to perform the specific data analysis has been generated and stored on a monitored test data source) (1010-1012). As the specific test data is generated and stored on a monitored test data source, the monitored test data source is automatically accessed, the specific test data is retrieved and the specific data analysis requested by the user is performed, using the retrieved test data (1014). For electrical PCN/EWR and functional EWR analysis as long as the first lot is tested, the automated analysis will start. Then, whenever, new data becomes available (e.g., data from additional lots), the reports generated by the report generator 170 based on the analysis (see detailed discussion below) will simply be updated. However, for functional PCN analysis it is preferred that data from at least three lots be available before the automated analysis is initiated. Those skilled in the art will recognize that the automated analysis can be accomplished using conventional statistical analysis techniques, including but not limited to, a comparison of experimental data to previously recorded data.

After the specific data analysis is completed at process 1014, a summary report, based on results of the specific data analysis, can be automatically generated (1016, see detailed discussion above of FIGS. 4-9). For example, a hardcopy of a summary report can be generated and output. Alternatively, a softcopy of a summary report can be generated, stored on the data storage device and/or automatically displayed on a designated web page. Such a soft copy summary report can further be generated with drill down capabilities allowing a user to link directly to the detailed results upon which various line items in the summary report are based. It should be noted that the summary report can include the results of the one or more requested data analyses for one or more experiments.

As the summary reports are completed and/or updated, the user can be automatically notified of the availability of the summary report (1018). For example, either the summary report itself or a web address for accessing a web page with the summary report can be automatically emailed to the user. Similarly at least one additional user can be automatically notified of the summary report. For example, either the summary report itself or a web address for accessing a web page with the summary report can be automatically emailed to a characterization engineer or any other user identified as having an interest in the results of the analysis.

After reviewing the summary reports and detailed drill downs, the requesting user (e.g., the manufacturing process engineer or integration engineer) may discuss the results with the characterization engineer/lead technology analyst and determine if additional or more detailed analysis is required. If so, the requesting user may submit a revised or new analysis request. Once all of the data analyses requested are completed, web reporting can cease and the request can be closed (1020-1022).

The embodiments of the invention can take the form of an entirely hardware embodiment, an entirely software embodiment or an embodiment including both hardware and software elements. In one embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

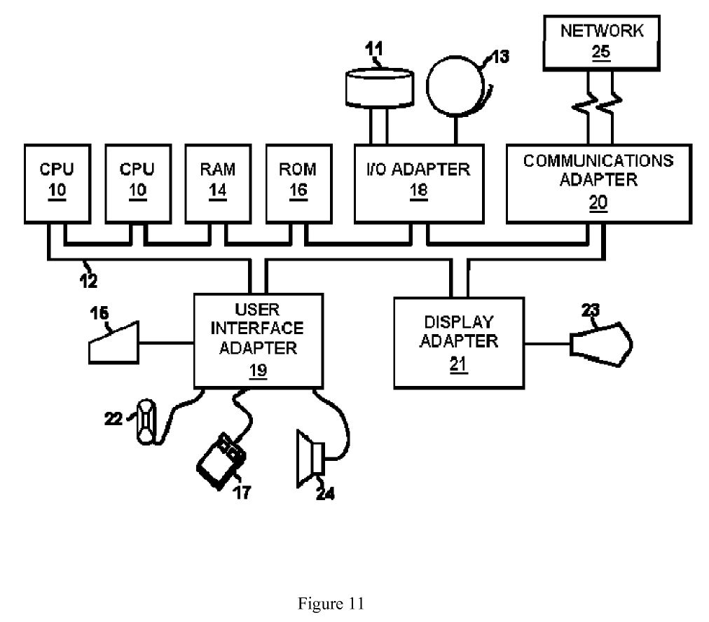

A representative hardware environment for practicing the embodiments of the invention is depicted in FIG. 11. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Therefore, disclosed above are embodiments of an automated data analysis system for use in a semiconductor product manufacturing environment and an associated method. The system provides a standardized data analysis request form on a graphical user interface (GUI). The standardized request form allows a user (e.g., a manufacturing process engineer and/or an integration engineer) to select an experiment (e.g., a wafer-level based yield split lot (EWR) analysis, a lot-level based process change notification (PCN) analysis, and lot-level based tool/mask qualification analysis) and a data analysis for a specific process module of interest. For each specific data analysis request, the system identifies critical test parameters, which are grouped depending on in-line test levels and integration/process levels (i.e., photolithography levels). Once the analysis request is submitted, the system links the analysis request to test data source(s) which maintain the test data. The system automatically monitors the test data source(s), searching for the critical test parameters. When the critical test parameters become available, the system automatically performs the requested statistical analysis, generates a summary report of the analysis and publishes the summary report (e.g., on a web page) with optional drill downs to more detailed reports/data. The summary report can highlight changes (e.g., in process or tools) which have a significant impact on functional yield. The system can further provide automatic e-mail notification of the published summary report to the requesting user as well as to other users having an interest in the summary report (e.g., the characterization engineers/lead technology analysts, etc.).

With such an automated system and method, as long as the requesting user has the experiments defined in the system, they only need a minimal amount of time to submit the analysis request through a friendly GUI interface. Neither requesting users (e.g., manufacturing process engineers or integration engineers) nor analysts (e.g., characterization engineers, who previously performed such analyses) need to spend time tracking the hardware in the line in order to start the data analysis. When the critical data required for the requested analysis becomes available, the analysis will started automatically. When, the analysis is completed an e-mail with a link to the data summary will be received by the relevant engineers. Such a system and method has the advantage of decreasing the turn around of EWR and PCN analyses for manufacturing and integration engineer teams and, thereby, to enhance yield learning and increase productivity. Additionally, such a system and method reduces the time spent by characterization engineers retrieving data and enables those engineers to focus on deeper data analysis and innovation learning. Finally, the standardize summary report format is more efficient for presentation before a process change review board, allows for process changes to be ranked based on functional yield, and further allows for greater information sharing and learning between different engineering teams.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the invention can be practiced with modification within the spirit and scope of the appended claims.

What is claimed is:

1. An automated data analysis system comprising:
a graphical user interface adapted to display a data analysis request form, said form comprising a plurality of input fields, and said form being adapted to allow a user to identify at least a specific experiment and a specific data analysis;
a data monitor in communication with said graphical user interface and with at least one test data source, wherein said data monitor is adapted to monitor said test data source to determine if specific test data, that is generated during said specific experiment and that is required to perform said specific data analysis, is stored in said test data source;
a data retriever in communication with said data monitor and said test data source, wherein said data retriever is adapted to retrieve said specific test data from said test data source;
a data analyzer in communication with said data retriever, wherein said data analyzer is adapted to receive said specific test data from said data retriever and to automatically perform said specific data analysis using said specific test data; and
a report generator in communication with said data analyzer and adapted to automatically generate a summary report based on results of said specific data analysis.

2. The automated data analysis system according to claim 1, all the limitations of which are incorporated herein by reference, wherein one of said input fields comprises a data analysis input field adapted to allow said user to make a selection of a specific process module and further to allow said user to make a selection of at least one of an in-line test level and a photolithography level for said specific process module and wherein said selection of said specific process module and said selection of said at least one of said in-line test level and said photolithography level allow said specific data analysis performed by said data analyzer to be automated and relevant.

3. The automated data analysis system according to claim 2, all the limitations of which are incorporated herein by reference, wherein said system further comprises:
a data storage device comprising stored lists of test data required for different types of data analyses, wherein said lists are grouped by process modules and further by in-line test levels and photolithography levels; and
a processor in communication with said graphical user interface, said data storage device and said data monitor, wherein said processor is adapted to automatically access said lists and, based on said selection of said specific process module and said selection of said at least one of said in-line test level and said photolithography level, to identify said specific test data generated during said specific experiment upon which said specific data analysis is to be performed.

4. The automated data analysis system according to claim 1, all the limitations of which are incorporated herein by reference, wherein one of said input fields comprises an experiment input field adapted to allow said user to make a selection of one of a wafer-level yield split lot analysis, a lot-level process change notification analysis, and a tool/mask qualification.

5. The automated data analysis system according to claim 1, all the limitations of which are incorporated herein by reference, further comprising a notification system in communication with said report generator and adapted to automatically notify said user of said summary report.

6. An automated data analysis system comprising:
a graphical user interface adapted to display a data analysis request form comprising a plurality of input fields adapted to allow a user to identify at least a specific experiment and a specific data analysis;
a data monitor in communication with said graphical user interface and at least one test data source, wherein said data monitor is adapted to monitor said test data source to determine if specific test data, that is generated during said specific experiment and that is required to perform said specific data analysis, is stored in said test data source;
a data retriever in communication with said data monitor and said test data source, wherein said data retriever is adapted to retrieve said specific test data from said test data source;
a data analyzer in communication with said data retriever, wherein said data analyzer is adapted to receive said specific test data from said data retriever and to automatically perform said specific data analysis using said specific test data; and
a report generator in communication with said data analyzer, wherein said report generator is adapted to automatically generate a summary report, based on results of said specific data analysis, and to display said summary report on a web page such that said summary report comprises links to said results.

7. The automated data analysis system according to claim 6, all the limitations of which are incorporated herein by reference, wherein one of said input fields comprises a data analysis input field adapted to allow said user to make a selection of a specific process module and further to allow said user to make a selection of at least one of an in-line test level and a photolithography level for said specific process module and wherein said selection of said specific process module and said selection of said at least one of said in-line test level and said photolithography level allow said specific data analysis performed by said data analyzer to be automated and relevant.

8. The automated data analysis system according to claim 7, all the limitations of which are incorporated herein by reference, wherein said system further comprises:
a data storage device comprising stored lists of test data required for different types of data analyses, wherein said lists are grouped by process modules and further by in-line test levels and photolithography levels; and
a processor in communication with said graphical user interface, said data storage device and said data monitor, wherein said processor is adapted to automatically access said lists and, based on said selection of said specific process module and said selection of said at least one of said in-line test level and said photolithography level, to identify said specific test data generated during said specific experiment upon which said specific data analysis is to be performed.

9. The automated data analysis system according to claim 6, all the limitations of which are incorporated herein by reference, wherein one of said input fields comprises an experiment input field adapted to allow said user to make a selection of one of a wafer-level yield split lot analysis, a lot-level process change notification analysis, and a tool/mask qualification.

10. The automated data analysis system according to claim 6, all the limitations of which are incorporated herein by reference, further comprising an automated email notification system in communication with said report generator and adapted to automatically send an email to said user indicating a web address for accessing said web page with said summary report.

11. An automated data analysis method comprising:
displaying, on a graphical user interface, a data analysis request form;
receiving, from a user, input field selections identifying at least a specific experiment and a specific data analysis;
automatically monitoring at least one test data source to determine if specific test data generated during said specific experiment and required for said specific data analysis is stored on said test data source;
as said specific test data is stored on said data storage device, automatically accessing said test data source, retrieving said specific test data, and performing said specific data analysis using said specific test data; and
automatically generating a summary report, based on results of said specific data analysis.

12. The automated data analysis method according to claim 11, all the limitations of which are incorporated herein by reference, wherein said receiving further comprises, in a data analysis input field, receiving a selection of a specific process module and, for said specific process module, a selection of at least one of an in-line test level and a photolithography level.

13. The automated data analysis method according to claim 12, all the limitations of which are incorporated herein by reference, further comprising:
storing, in a data storage device, lists of test data required for different types of data analyses, wherein said lists are grouped by process modules and further according to in-line test levels and photolithography levels; and
automatically accessing said lists and, based on said selection of said specific process module and said selection of said at least one of said in-line test level and said photolithography level, identifying said specific test data generated during said specific experiment upon which said specific data analysis is to be performed.

14. The automated data analysis method according to claim 11, all the limitations of which are incorporated herein by reference, wherein said receiving further comprises, in an experiment input field, receiving a selection of one of a wafer-level yield split lot analysis, a lot-level process change notification analysis and a tool/mask qualification.

15. The automated data analysis method according to claim 11, all the limitations of which are incorporated herein by reference, further comprising automatically notifying said user of said summary report.

16. The method according to claim 11, all the limitations of which are incorporated herein by reference, further comprising, displaying said summary report on a web page.

17. The method according to claim 16, all the limitations of which are incorporated herein by reference, wherein said displaying further comprises providing links on said web page to said results.

18. The method according to claim 17, all the limitations of which are incorporated herein by reference, wherein said links provide drill down access to detailed reports upon which line items in said summary report are based.

19. The method according to claim 18, wherein said detailed reports comprise at least one of box and plot trends, scatter plots, histograms, box plots and tables.

20. The method according to claim 16, all the limitations of which are incorporated herein by reference, further comprising automatically sending an email to said user indicating a web address for accessing said web page with said summary report.
